(19) United States
(12) Patent Application Publication
(10) Pub. No.: US 2012/0205325 A1
(43) Pub. Date: Aug. 16, 2012

(54) PRODUCT DISPLAY SYSTEM

(75) Inventors: Gary M. Richter, Waukesha, WI (US); Ryan Brobst, Grafton, WI (US)

(73) Assignee: DCI Marketing, Inc. (a Wisconsin corporation), Milwaukee, WI (US)

(21) Appl. No.: 13/369,143

(22) Filed: Feb. 8, 2012

Related U.S. Application Data
(60) Provisional application No. 61/440,775, filed on Feb. 8, 2011.

(51) Int. Cl. A47F 1/04; E05B 73/00

(52) U.S. Cl. 211/4

(57) ABSTRACT

A product display system is configured to display small items and signage in a retail environment. The display system includes a front cover that is removably attached to a rear cover by using a key to disengage the front cover from the rear cover. The product display system includes a tether for securing the small item and includes space for attaching signage associated with the item.

### CROSS-REFERENCE TO RELATED APPLICATION

This application is based on and claims priority to U.S. Provisional Patent Application No. 61/440,775 filed on Feb. 8, 2011, which is incorporated herein by reference in its entirety for all purposes.

### FIELD OF THE INVENTION

The present invention relates generally to the field of advertising displays. More particularly, the present invention relates to a system for displaying a small item so that it may be manipulated easily by a user while both prohibiting unauthorized removal of the object from the premises and allowing retailers to quickly and efficiently change the configuration of a retail space.

### BACKGROUND

In the field of advertising displays, there is a need to display small items, typically electronics, such as cell-phones, camcorders, cameras, and remote controls in a way that allows consumers to touch and hold the device prior to purchase. Traditionally, such items were displayed in locked cases or behind counters where consumers could only get access to the items after consulting a sales associate. As the number of small electronic devices available for purchase increased dramatically, it became necessary for retailers to change the way small electronics are displayed. Retailers want to allow potential customers to handle the devices in the store, but lack the staffing and/or security to allow them to do so without fear of rampant theft. Small electronic devices, even so called “dummy” phones, are valuable and are attractive targets for thieves. In order to facilitate customer interaction with the devices while simultaneously preventing theft, retailers employ a wide variety of security measures.

One common solution to the above problem is to anchor the item to a shelf, table, or display. Retailers have implemented a wide range of anchors, with most falling into one of two categories: recoiling tether with mechanical attachment, or recoiling tether with adhesive attachment. Both solutions have also been adapted to provide power to the device and/or alarm capabilities in the event that the device is removed from the tether. The anchors are typically permanently attached to shelves, tables, or displays or are integrated into the displays. Both solutions have significant limitations.

Typical mechanical attachment systems include a pullbox and tether that are attached to a cage or mechanical claw that wraps around the secured device and locks in place. Mechanical attachment solutions tend to be quite bulky due to the fact that they must be adjustable to accommodate devices of varying size and shape. The adjustable nature of the mechanical attachment also causes mechanical attachments to be more complex, and are typically made of metal components, all of which contribute to increased cost of the anchors. The added bulk of the mechanical attachment also diminishes the consumer experience because the potential buyer is unable to get a true sense of the size and feel of the secured device.

Adhesive attachment solutions tend to be much less bulky than their mechanical counterparts but suffer from a critical limitation: once the adhesive is bonded to the device, it is very difficult, if not impossible to remove it without damaging either the anchor or the secured device. The use of adhesive attachment becomes an issue if and when the store wishes to re-planogram. As used herein “planogram” refers to arranging items in a retail environment using a diagram of fixtures and products that illustrates how and where retail products should be displayed to increase customer purchases.

Another disadvantage present in existing display solutions is the permanent or semi-permanent attachment of the anchor to a table, shelf, or display. Commonly, nearby the small item on display is signage displaying pertinent information about the item such as price or a description of the item. Thus, each time the store re-planograms, not only must the item be removed from the anchor, but any signage associated with the item must be removed from the display and kept with the item so it may be displayed in a new location. Keeping everything together and in good condition over time and after many re-planograms is a problem for retailers. In particular, the signage is commonly lost, damaged, or separated from the item to which it pertains.

In the rapidly changing world of cell phones and small electronics, the ability of a retailer to quickly and easily re-planogram without damaging the products or the displays is extremely important. Thus, there is a need for a product display system, such that a significant portion of the display may be moved to a different location in one piece, for displaying a small item that includes a tether and attachment means for the item and has provisions for attaching pertinent signage.

### SUMMARY

The present invention relates to a display system that securely displays small items in the retail environment and allows a retailer to quickly and easily re-planogram. The invention includes an attachment plate for securing the product display system to a base. Attached to the attachment plate is a rear cover adapted to semi-permanently attach to the attachment plate. A front cover is adapted to support a retention mechanism and to removably attach to the rear cover. Attached to the retention mechanism is a tether that is adapted to attach to a small item.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a product display in accordance with the invention;

FIG. 2 is an exploded perspective view of the product display of FIG. 1;

FIG. 3 a front view of the product display of FIG. 1;

FIG. 4 is a top view of the product display of FIG. 1;

FIG. 5 is a side view of the product display of FIG. 1;

FIG. 6 is a front perspective view of the back cover of the product display of FIG. 1;

FIG. 7 is a rear perspective view of the back cover of FIG. 6;

FIG. 8 is a top view of the back cover of FIG. 6;

FIG. 9 is a front view of the back cover of FIG. 6;

FIG. 10 is a right side view of the back cover of FIG. 6;

FIG. 11 is a left side view of the back cover of FIG. 6;

FIG. 12 is a front perspective view of the front cover of the product display of FIG. 1;

FIG. 13 is a rear perspective view of the front cover of FIG. 12;

FIG. 14 is a bottom view of the front cover of FIG. 12;

FIG. 15 is a left side view of the front cover of FIG. 12;

FIG. 16 is a right side view of the front cover of FIG. 12;

FIG. 17 is a front perspective view of a device cradle of the product display of FIG. 1;

FIG. 18 is rear perspective view of the device cradle of FIG. 17;

FIG. 19 is a front view of the device cradle of FIG. 17;

FIG. 20 is a top view of the device cradle of FIG. 17;

FIG. 21 is a side view of the device cradle of FIG. 17;

FIG. 22 is a perspective view of an accent panel of the product display of FIG. 1;

FIG. 23 is a top view of the accent panel of FIG. 22;

FIG. 24 is a front view of the accent panel of FIG. 22;

FIG. 25 is a side view of the accent panel of FIG. 22;

FIG. 26 is a perspective view of a key of the product display of FIG. 1;

FIG. 27 is a top view of the key of FIG. 26;

FIG. 28 is a front view of the key of FIG. 26;

FIG. 29 is a side view of the key of FIG. 26;

FIG. 30 is a perspective view of a sign holder of the product display of FIG. 1;

FIG. 31 is a front view of the sign holder of FIG. 30;

FIG. 32 is a top view of the sign holder of FIG. 30;

FIG. 33 is a side view of the sign holder of FIG. 30;

FIG. 33A is a detail view of the sign holder of FIG. 30;

FIG. 34 is a front perspective view of another embodiment of a product display in accordance with the present invention;

FIG. 35 is a rear perspective view of the product display of FIG. 34;

FIG. 36 is another rear perspective view of the product display of FIG. 34 with the rear cover removed;

FIG. 37 is a front perspective view of an attachment plate of the product display of FIG. 34; and

FIG. 38 is a rear perspective view of the attachment plate of FIG. 37.

### DETAILED DESCRIPTION

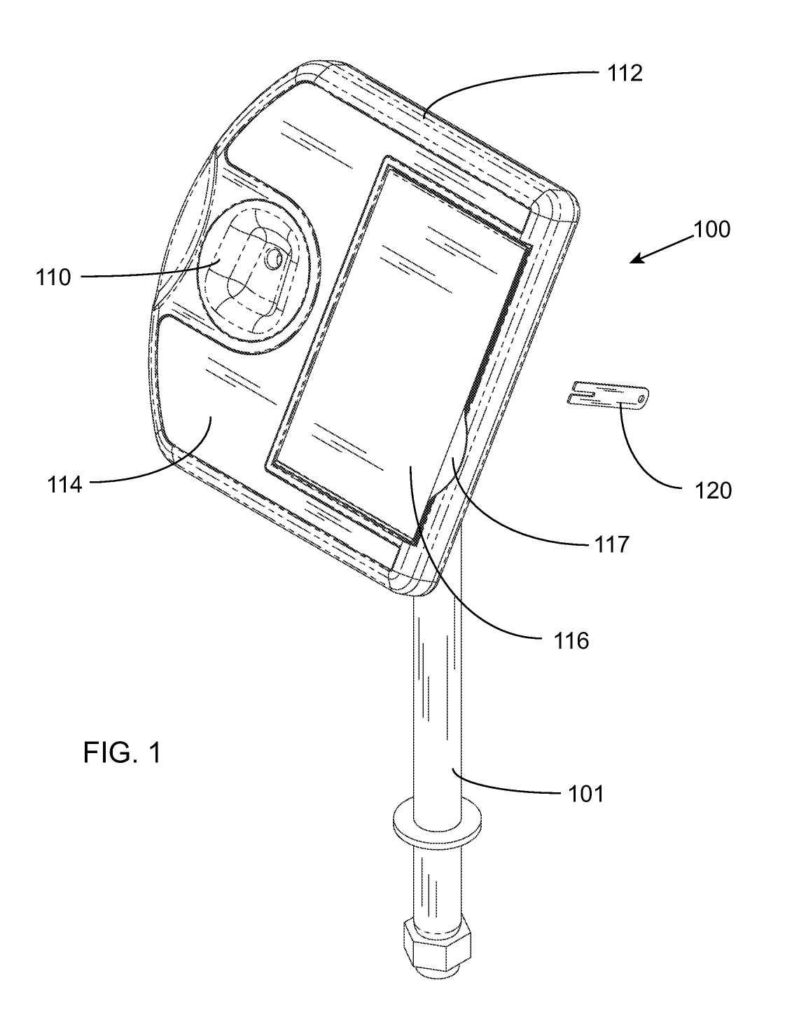

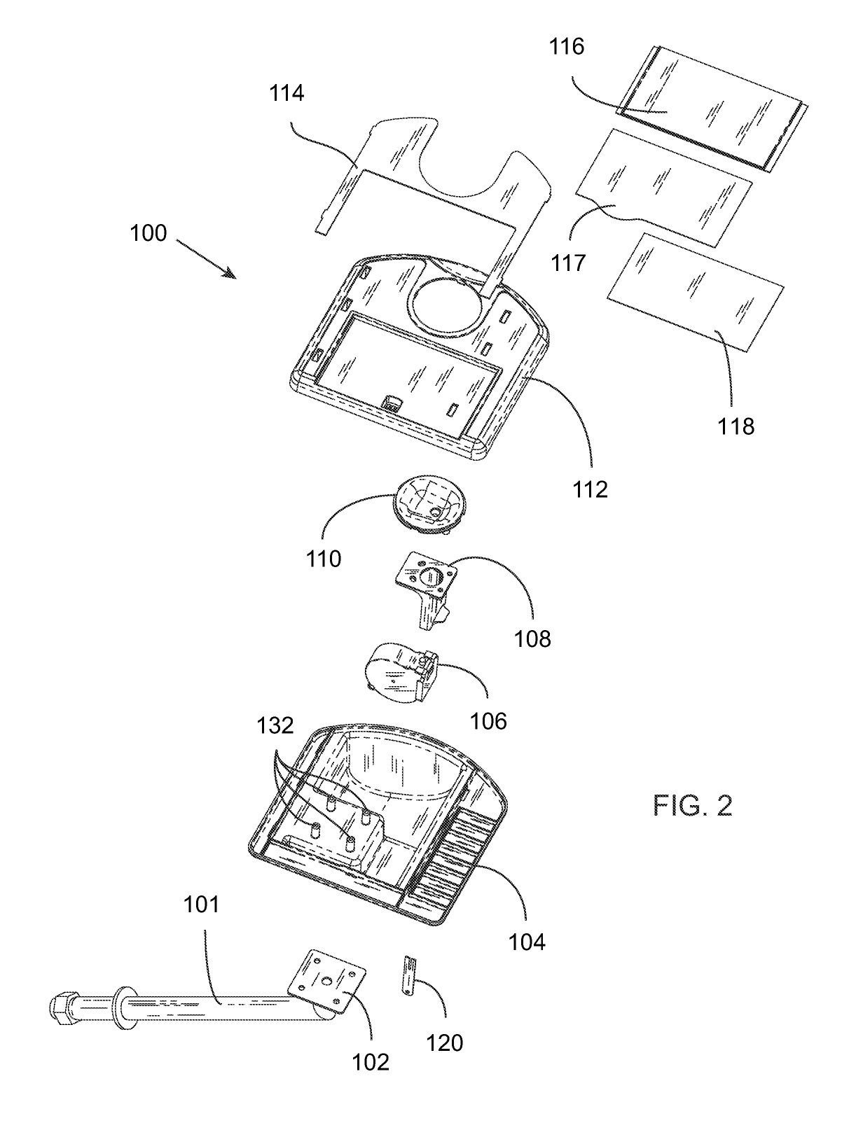

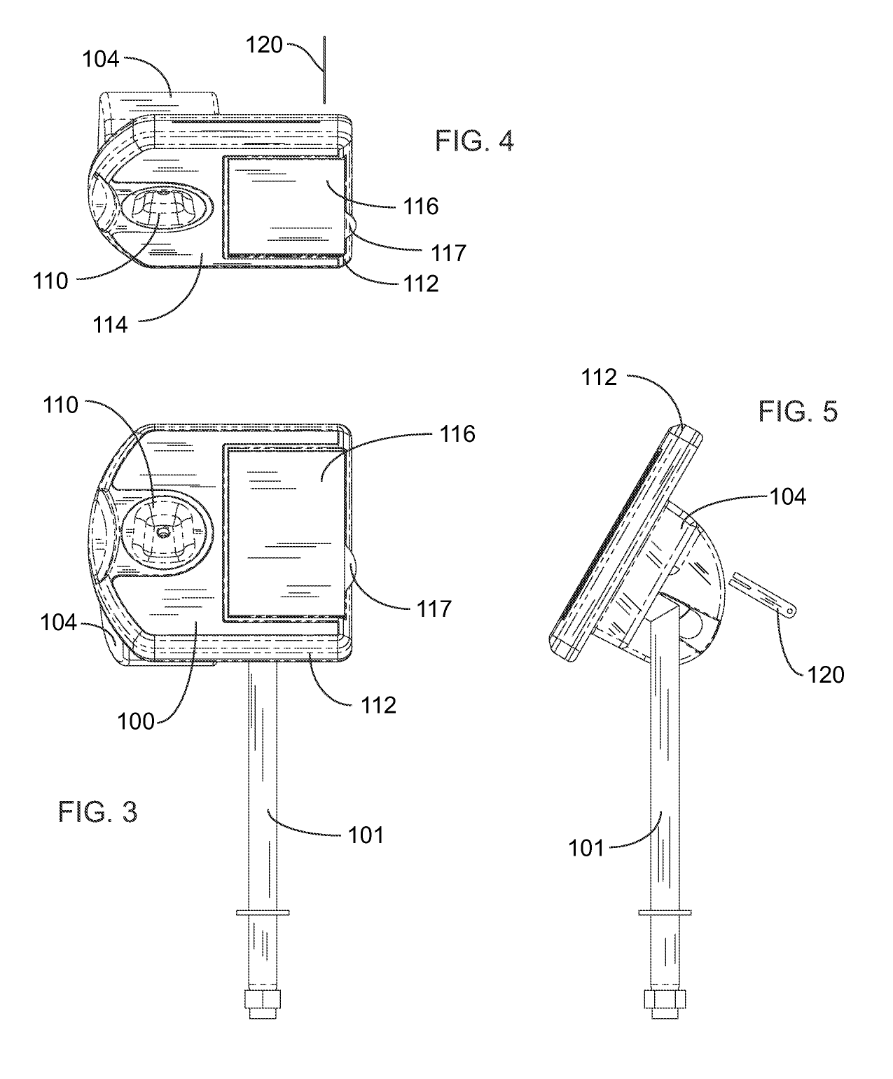

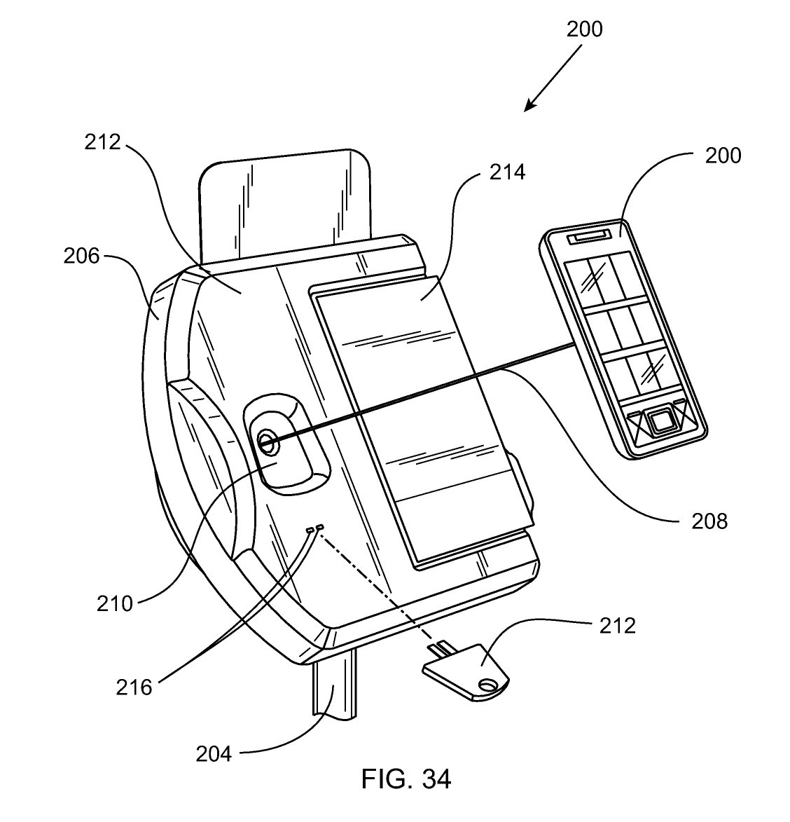

FIGS. 1-33 show one embodiment of a product display system 100 in accordance with the invention. As shown in FIGS. 1-5, the product display system 100 includes a post 101, an attachment plate 102, a rear cover 104, a pullbox 106, a tether (not shown) a tether guide 108, device cradle 110, a front cover 112, an accent panel 114, a sign holder 116, a key 120, and attachment means for attaching a small device (not shown). In the embodiment shown, the pullbox 106 is attached to the tether guide 108, which in turn is attached to the device cradle 110. The tether guide 108 includes a mounting flange 142 that provides a surface to which the device cradle 110 is attached.

The post 101 is secured to a display surface (not shown) in a retail environment and includes the attachment plate 102, which provides a surface on which to mount the rear cover 104. In the embodiment shown, the rear cover 104 includes mounting posts 132 for mounting the rear cover 104 to the attachment plate 102. The rear cover 104 is attached to the attachment plate 102 with a plurality of fasteners (not shown). Alternative attachment means such as adhesive or welding may be used without departing from the invention. Additionally, an embodiment may be contemplated where the post 101, attachment plate 102, and rear cover 104, are formed either as one piece or some other combination of separate attached pieces.

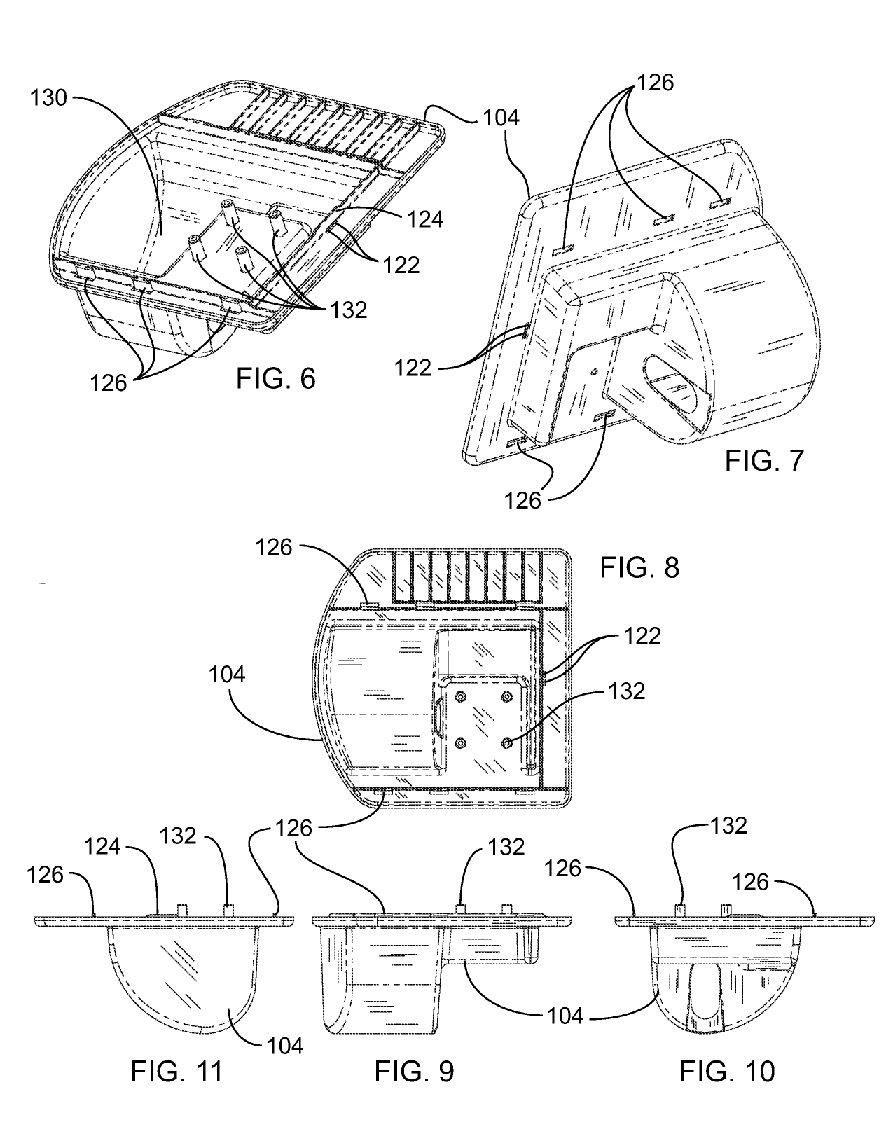

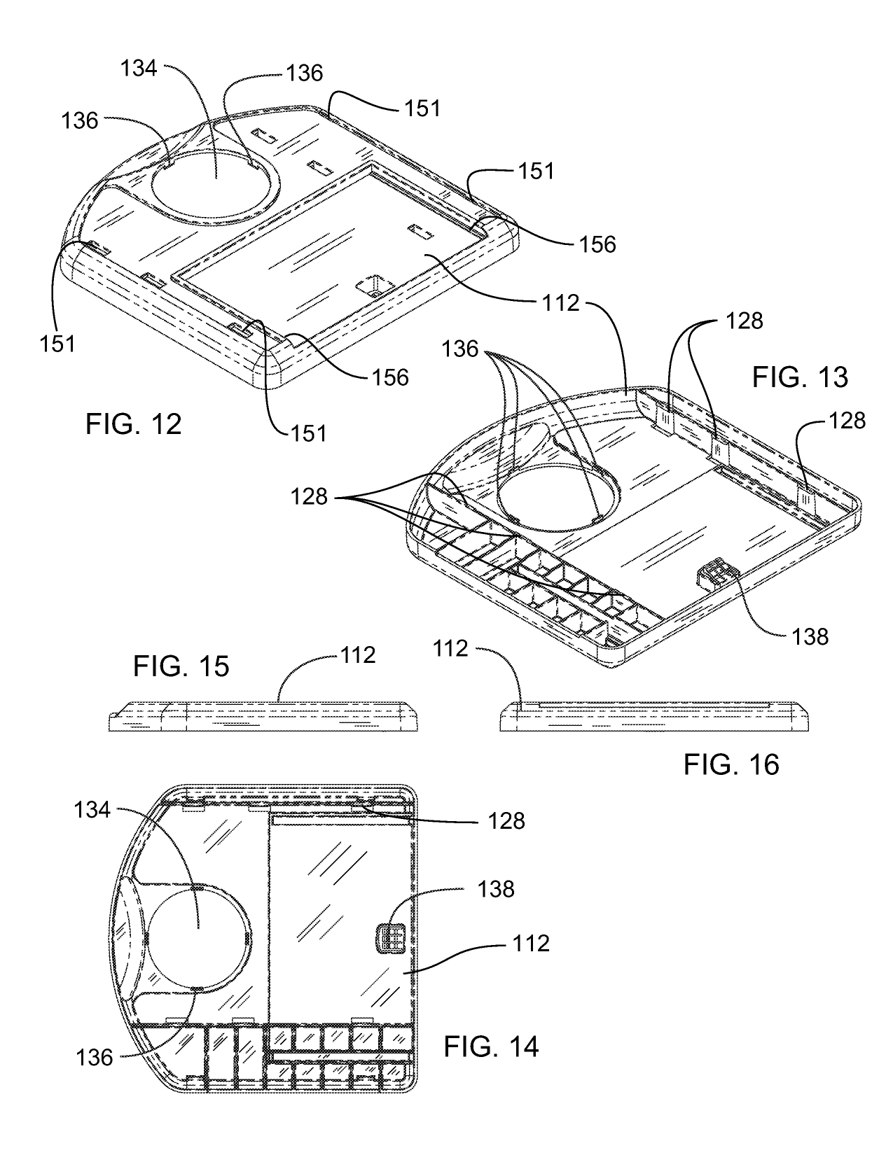

FIGS. 6-11 show the rear cover 104 in greater detail. The rear cover 104 includes at least one keyhole 122. Proximate to the at least one keyhole 122 is a ridge 124 that is adapted to retain the front cover 112 when it is attached to the rear cover 104. The rear cover 104 also includes a plurality of attachment openings 126 that engage attachment protrusions 128 on the front cover 112 (see FIGS. 12-16). The rear cover 104 also includes a recess 130 that provides space for the pullbox 106. The recess 130 is also large enough to allow the front cover 112 to be attached to the rear cover 104 with the pullbox 106 already attached.

Turning now to FIGS. 12-16, the front cover 112 is shown in greater detail. The front cover 112 is configured to be customer facing and to be easily attached and removed from the rear cover 104. A number of components are mounted to the front cover 112 so that when it is removed from the rear cover 104, all of those components remain mounted to the front cover. Such components include the pullbox 106, tether guide 108, device cradle 110, accent panel 114, and sign holder 116 (see FIG. 1).

In the embodiment shown, the front cover includes a plurality of resilient fingers 138 that lock the front cover 112 when it is attached to the rear cover 104. To install the front cover 112 on the rear cover 104, the front cover 112 is positioned such that the attachment protrusions 128 are within the attachment openings 126 of the rear cover. The front cover 112 is then moved horizontally such that the resilient fingers 138 pass over the ridge 124 of the rear cover 104. When the fingers 138 pass over the ridge 124, they deform slightly so that when the front cover 112 is in its final position, the resilient fingers 138 spring into position proximate the ridge 124. When the front cover 112 is properly installed, it may not be removed from the rear cover 102 unless the key 120 is used to depress the resilient fingers 138, allowing them to pass back over the ridge 124. Once the front cover 112 is disengaged from the rear cover 104, it, along with anything attached to it, may be easily moved and attached to another rear cover elsewhere in the store. Likewise, another front cover 112 from a different location in the store may be similarly attached to the rear cover 104 that was just vacated. Thus, retailers may quickly and easily re-planogram their stores by simply moving front covers 112 between rear covers 104.

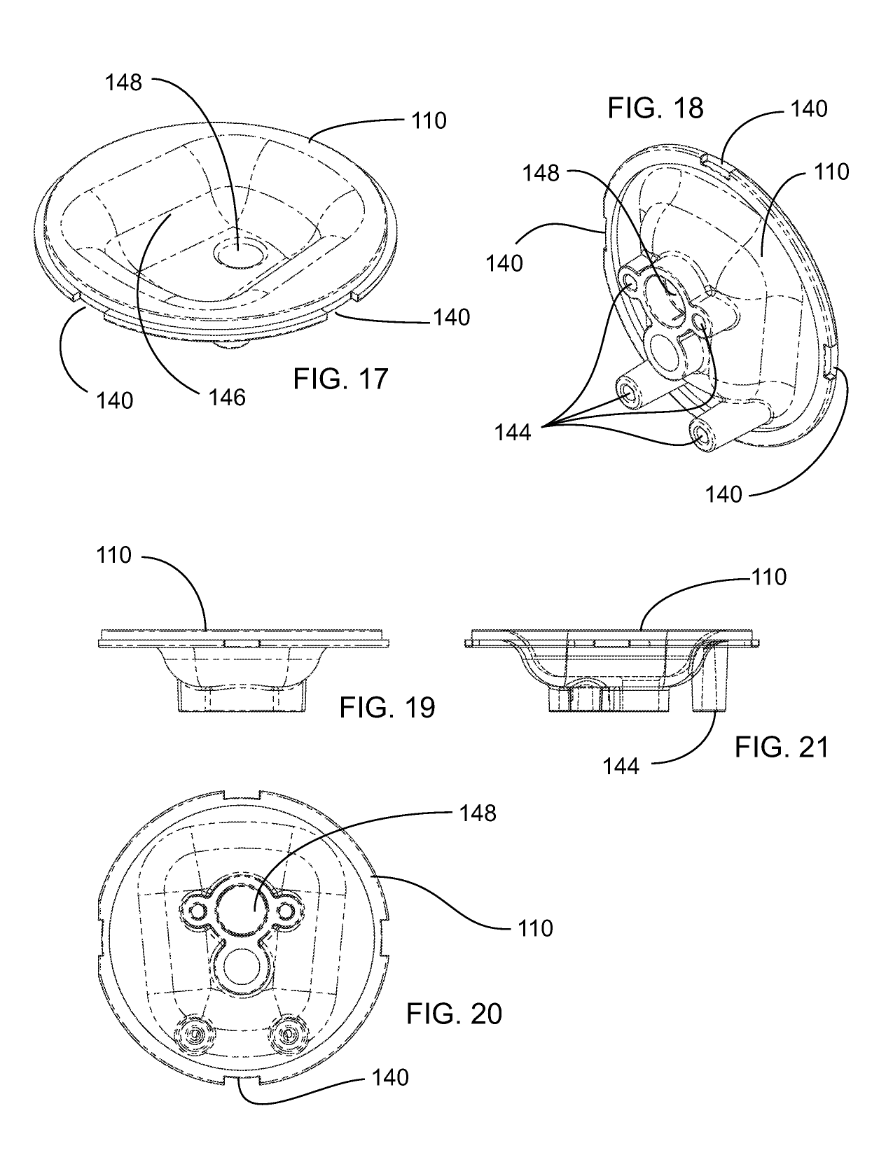

The front cover 112 includes an interchangeable socket 134 for attaching different device cradles 110 as necessary. The inclusion of an interchangeable socket 134 allows the product display 100 to accommodate a variety of pullboxes 106 and corresponding mounting plates (not shown). The interchangeable socket 134 includes a plurality of mounting protrusions 136 that engage corresponding mounting features 140 on the device cradle 110 (see FIGS. 17-21).

FIGS. 17-21 show detail of the device cradle 110 of the present embodiment. The device cradle 110 includes mounting bosses 144, a socket 146, a tether hole 148, and a plurality of mounting features 140. The mounting bosses 144 are adapted to accept threaded fasteners through the tether guide mounting flange 142 to attach the device cradle 110 to the pullbox 106. The socket 146 is configured to align a device attachment apparatus (not shown) and to prevent the device attachment apparatus from rotating. The socket 146 may be of any shape or size to accommodate any device attachment apparatus.

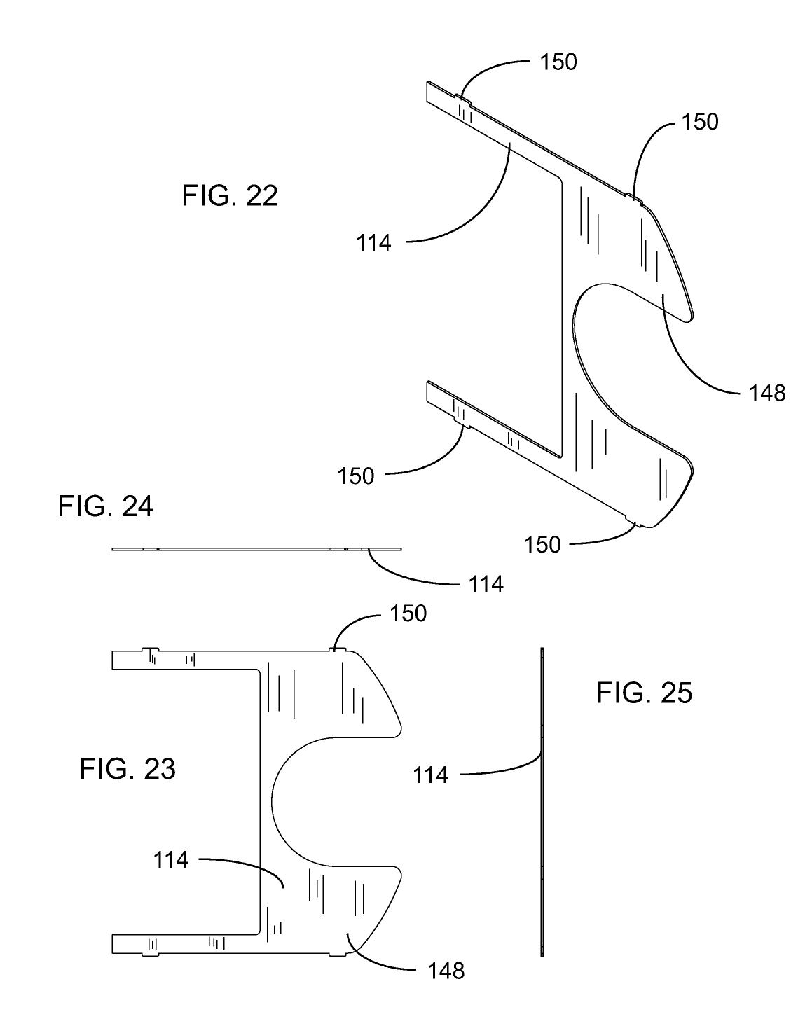

Turning now to FIGS. 22-25, an accent panel 148 in accordance with the invention is shown. In the embodiment shown, the accent panel 148 is a removable, flexible substrate that may be removably attached to the front cover 112. As shown, the accent panel 148 is made of flexible plastic, but other materials may be used without departing from the invention. The accent panel 148 includes a plurality of mounting tabs 150 that fit into corresponding mounting holes 151 on the front cover 112. The accent panel 148 may be a solid color or may have a pattern or advertising copy printed on it.

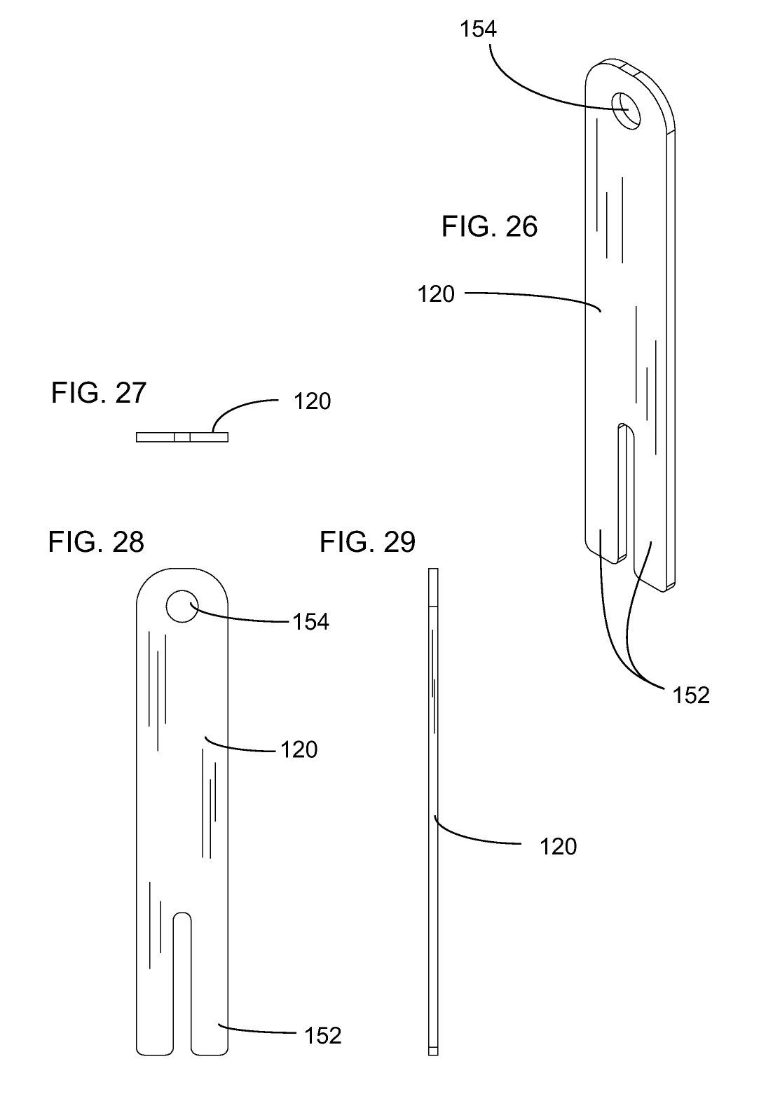

FIGS. 26-29 show a key 120 in accordance with the invention. As shown, the key 120 includes at least one blade 152 that is adapted to fit into the keyhole 122 on the rear cover 104. When the at least one blade 152 enters the keyhole 122, it contacts and elastically deforms the resilient fingers 138 of the front cover 112, thus allowing the front cover to be removed from the rear cover 104. The key 120 also includes a key chain hole 154 for attachment to a key chain, key fob, or other place. In the embodiment shown, the key 120 is made of plastic, but other materials may be used without departing from the invention. Other key 120 and finger 138 designs could also be used without departing from the invention.

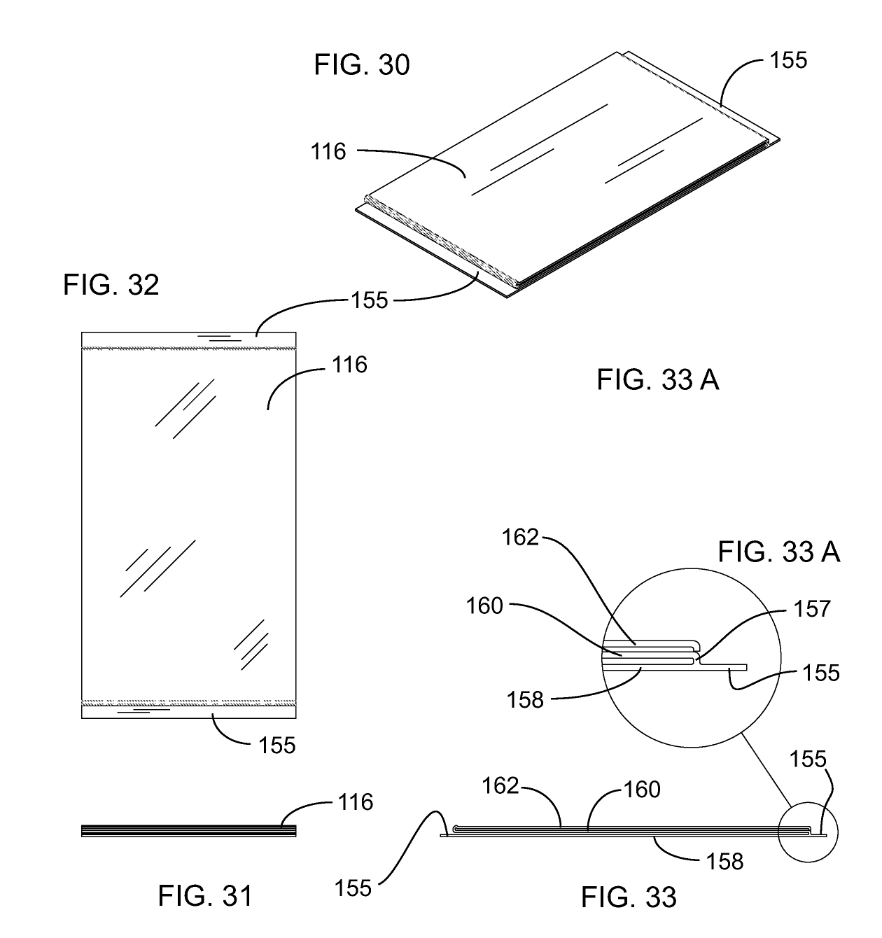

Turning now to FIGS. 30-33, a sign holder 116 in accordance with the invention is shown. The sign holder 116 is adapted to attach to the front cover 112 and to display graphics (not shown). The sign holder 116 is attached to the front cover 112 by inserting at least one mounting flange 155 into corresponding slots 156 on the front cover. In the embodiment shown, the sign holder 116 is made of one continuous piece of resilient clear plastic and includes a living hinge 156, allowing the retailer to display two graphics simultaneously. The continuous piece of resilient plastic has three distinct parts: (1) a primary graphic cover 158, a secondary graphic base 160, and a secondary graphic cover 162. A first graphic is captured between the primary graphic cover 158 and the front cover 112. A second graphic is captured between the secondary graphic base 160 and the secondary graphic cover 162. Of course, other configurations of the sign holder 116 may be contemplated without departing from the invention. Such alternative configurations include but are not limited to a sign holder that is configured to display more or less than two graphics, or a sign holder that is made of separate parts.

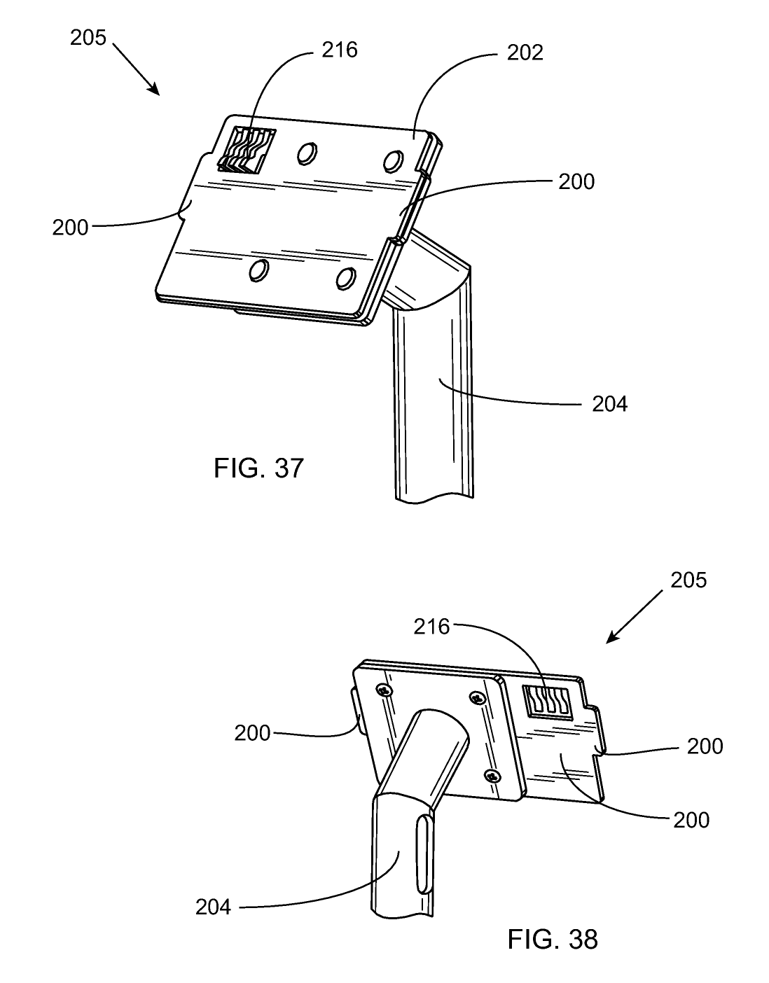

FIGS. 34-38 show an alternative embodiment of a product display 200 in accordance with the invention. In the alternative embodiment, the locking mechanism described above is integrated into an attachment plate 202 (see FIG. 37) rather than a rear cover. The product display 200 includes an attachment plate 202, a post 204, and a product display 206. The post 204 and the attachment plate 202 together make a base 205. A pullbox 207 is enclosed within the product display 206 and includes a tether 208 that is attached to a display item 210. Like the previously discussed embodiment, the product display 206 includes a tether guide (not shown), device cradle 210, accent panel 212, and sign holder 214. The product display 206 may be removed from the attachment plate by inserting a key 212 into a corresponding keyhole 216 on the product display.

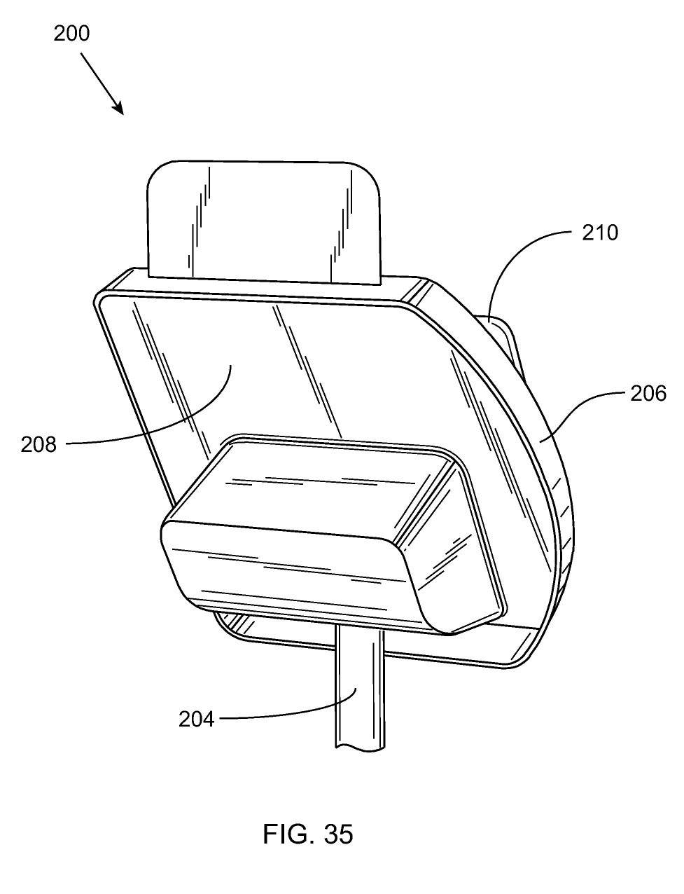

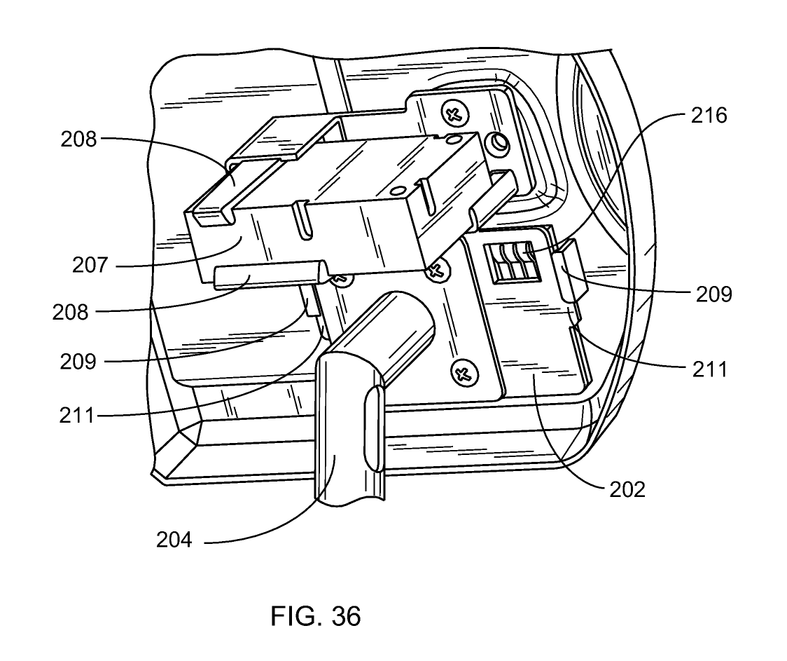

FIG. 35 is a rear perspective view of the embodiment of the product display bracket of FIG. 34. FIG. 35 shows the back of the product display 206 as it is installed on the attachment plate 202. Nothing on the inside of the product display 206 is visible when it is installed on the attachment plate 202 because it is covered by a back plate 208 that is permanently attached to the product display.

FIG. 36-38 show how the pullbox 207 is attached within the product display 206 and how the attachment plate 202 engages with the product display. Other attachment means between the pullbox 207 and product display 206, and between the attachment plate 202 and the product display may be used without departing from the invention. The pullbox 207 is removably attached to the product display 206 by at least one retention clip 208. In the embodiment shown, the retention clips 208 are resilient plastic that allow the pullbox 207 to be easily removed and replaced.

An operator installs the product display 206 on the attachment plate 202 by aligning at least one retention clip 209 with at least one alignment flange 211 on the attachment plate and then lowering the product display into position such that a plurality of resilient fingers 216 on the attachment plate engage the product display to lock it in place. When the key 212 is inserted into the corresponding keyholes 214 (see FIG. 35) on the product display 206, the key 212 elastically deforms the fingers 212 and allows the product display 206 to be removed from the attachment plate 202.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A product display system comprising:
an attachment plate for securing the product display system to a base;
a rear cover adapted to removably attach to the attachment plate and including at least one keyhole;
a front cover adapted to support a retention mechanism, to removably attach to the rear cover, and including at least one resilient finger adapted to engage a surface on the rear cover when the front cover is attached to it;
a tether attached to the retention mechanism on a first end and adapted to attach to an item on a second end;
a key adapted to be inserted into the at least one keyhole and to elastically deform the at least one resilient finger thereby allowing some or all of the front cover to be removed from the rear cover.

2. The product display system of claim 1, wherein the front cover is further adapted to provide at least one signage display area.

3. The product display system of claim 2, wherein a sign holder is attached to the signage display area.

4. The product display system of claim 3 wherein the sign holder is adapted to display a plurality of graphics simultaneously.

5. The product display system of claim 1, wherein the retention mechanism is a spring-loaded pullbox.

6. The product display system of claim 1, wherein the front cover includes a removable socket adapted to support the small item.

7. The product display system of claim 6, wherein the removable socket is further adapted to align the small item in a desired orientation.

8. The product display system of claim 1, wherein an accent panel is adapted to removably attach to the front cover.

9. A product display system comprising:
an attachment plate for securing the product display system to a base;
a front cover supporting a retention mechanism and removably attached to the rear cover, the front cover including at least one keyhole;
a rear cover removably attached to the attachment plate and including at least one resilient finger that engages a surface on the front cover when the front cover is attached to the rear cover;
a tether extending from the retention mechanism, the tether attachable to a small item;
a key dimensioned for insertion into the at least one keyhole so as to elastically deform the at least one resilient finger thereby allowing the front cover to be removed from the rear cover.

10. The product display system of claim 9, wherein the front cover is further adapted to provide at least one signage display area.

11. The product display system of claim 10, wherein a sign holder is attached to the signage display area.

12. The product display system of claim 11 wherein the sign holder is adapted to display a plurality of graphics simultaneously.

13. The product display system of claim 9, wherein the retention mechanism is a spring-loaded pullbox.

14. The product display system of claim 9, wherein the front cover includes a removable socket adapted to support the small item.

15. The product display system of claim 14, wherein the removable socket is further adapted to align the small item in a desired orientation.

16. The product display system of claim 9, wherein an accent panel is adapted to removably attach to the front cover.

17. A product display system comprising:
a housing adapted to contain a retention mechanism and to removably attach to an attachment plate and including at least one keyhole;
the attachment plate adapted to secure the housing to a base and including at least one resilient finger adapted to engage a surface on the housing;
a tether attached to the retention mechanism on a first end and adapted to attach to a small item on a second end;
a key adapted to be inserted into the at least one keyhole and to elastically deform the at least one resilient finger to release some or all of the housing from the attachment plate; and
a back plate adapted to cover the retention mechanism and attachment plate while the housing is attached to the attachment plate.

18. The product display system of claim 17, wherein the housing is further adapted to provide at least one signage display area.

19. The product display system of claim 18, wherein a sign holder is attached to the signage display area.

20. The product display system of claim 19 wherein the sign holder is adapted to display a plurality of graphics simultaneously.

21. The product display system of claim 17, wherein the retention mechanism is a spring-loaded pullbox.

22. The product display system of claim 17, wherein the front cover includes a removable socket adapted to support the small item.

23. The product display system of claim 22, wherein the removable socket is further adapted to align the small item in a desired orientation.

24. The product display system of claim 17, wherein an accent panel is adapted to removably attach to the front cover.
